(19) United States
(12) Patent Application Publication
(10) Pub. No.: US 2025/0313245 A1
(43) Pub. Date: Oct. 9, 2025

(54) Sack Truck That Can Be Converted Into a Four-Wheeled Hand Truck

(71) Applicant: Jochum Bierma, Lichtenberg (AT)

(72) Inventor: Jochum Bierma, Lichtenberg (AT)

(21) Appl. No.: 18/884,485

(22) Filed: Sep. 13, 2024

(30) Foreign Application Priority Data
Apr. 4, 2024 (AT) A50302/202

(51) Int. Cl. B62B 1/00; B62B 3/02

(52) U.S. Cl. CPC B62B 1/002; B62B 3/02

(57) ABSTRACT

A sack truck convertible into a four-wheeled hand truck with a main frame having a receiving nose plate at one foot end and two running wheels opposite the receiving nose plate. A subframe carries at least one steering wheel in the foot region, with a sliding guide which can be pivoted at the handle end of the main frame about a pivot axis parallel to the axes of the running wheels. A link, between the main frame and the subframe, articulates on the subframe in the foot region thereof about an axis parallel to the pivot axis. The subframe is guided in the sliding guide to slide freely between two end positions limited by stops that determine the positions for the sack truck and the hand truck, and that the link is mounted on the main frame so as to be stationary and pivotable to improve handling conditions.

### FIELD OF INVENTION

The invention relates to a sack truck which can be converted into a four-wheeled hand truck.

### BACKGROUND OF THE INVENTION

In order to convert a two-wheeled sack truck into a four-wheeled hand truck in a simple manner, it is known (U.S. Pat. No.10 864 933 B2) to mount a subframe at the handle end of the main frame forming the sack truck with the two running wheels and the receiving nose plate so that the subframe can be pivoted about a pivot axis parallel to the axes of the running wheels and is slidable in the longitudinal direction, so that the pivot axis is held in an inoperative state pivoted in against the main frame in the sack truck position that is limited by a stop, in which inoperative state the steering wheels provided in the foot region of the subframe come to rest unused above the running wheels of the main frame. If, however, the subframe is pivoted out of the inoperative state into a pivot position running transversely to the main frame and extended relative to the main frame into a working position that is limited by a stop, in this way, the steering wheels of the subframe now located in the area of the handle end below the main frame come into use, whereas the longer subframe section, which, in the hand truck function, protrudes upwards above the main frame forming an substantially horizontal support platform, can be used as a handle part for guiding the four-wheeled hand truck. Due to the ability to slide freely of the subframe between the two end settings, there is the disadvantage that handling is made more difficult for the sack truck on the one hand and for the hand truck on the other, inasmuch as there is a risk upon release of one of the two frames and the reciprocal pivoting and sliding displacements occur in an uncontrolled manner due to gravity.

In order to utilize an intermediate position resulting from the conversion of a two-wheeled sack truck into a four-wheeled hand truck, in which intermediate position the main frame forms a support platform which is inclined relative to the ground, it is also known (U.S. Pat. No. 6 364 328 B1) to articulate a sliding guide for a subframe at the handle end of the main frame, to which a link is articulated in the foot region about an axis parallel to the pivot axis of the sliding guide. This link is slidably guided parallel to the main frame at the opposite end and can be locked in predetermined sliding positions with respect to the main frame. Since the sliding guide for the subframe is provided with latches which hold the subframe in various sliding positions, a triangular bracket can be created between the main frame and the subframe, which is held in a sliding-proof position but can be pivoted in relation to the main frame, by means of the link, which is held in a sliding-proof position in relation to the main frame and subframe, thus creating stable conditions for the two working positions of the hand truck. Apart from the additional construction effort associated with an intermediate position for the hand truck, the handling when converting from a sack truck to a hand truck and vice versa from a hand truck to a sack truck must again be regarded as disadvantageous, inasmuch as the displacements between the main frame and subframe required for the conversion can only be carried out in a certain sequence and after certain locking or unlocking operations.

### SUMMARY OF THE INVENTION

The invention is therefore based on the task of reconfiguring a sack truck that can be converted into a four-wheeled hand truck in such a way that the conversion can be carried out in a simpler manner without having to comply with predetermined handling sequences.

In an aspect, the invention is directed towards a sack truck convertible into a four-wheeled hand truck, the convertible sack truck having a main frame having a receiving nose plate at one foot end and two running wheels on the side opposite the receiving nose plate, with a subframe carrying at least one steering wheel in the foot region, with a sliding guide for the subframe, which can be pivoted at the handle end of the main frame about a pivot axis parallel to the axes of the running wheels, and with a link between the main frame and the subframe, which link is articulated on the subframe in the foot region thereof about an axis parallel to the pivot axis. Starting out with a sack truck of the type described above that can be converted into a four-wheeled hand truck, the invention solves the task set forth, in that the subframe is guided in the sliding guide so that it can slide freely between two end positions that are limited by stops that determine the sack truck position on the one hand and the hand truck position on the other, and in that the link is mounted on the main frame so that it can pivot in a fixed position.

A constraining guide for the subframe relative to the main frame is ensured by the link, which is articulated to the two frames in a fixed position, which prevents an uncontrolled movement between the two frames when the sack truck is converted into a hand truck and vice versa from a hand truck into a sack truck. If the sack truck position is assumed, the subframe is pivoted away from the main frame about its pivot axis in the area of the handle end of the main frame after a latch between the subframe and the main frame has been released, wherein a gravity-induced state of equilibrium for the subframe results in each inclined position of the main frame, which state of equilibrium is determined by the triangle formed by the articulation points of the link and the pivot axis between the subframe and the main frame. The weight load on the subframe causes a weight moment on the link which counteracts any swinging out of the subframe. This also means that when the steering wheels of the subframe are placed on the ground, the subframe does not swing out from the main frame beyond a ground normal position and consequently there is no weight moment that swings the subframe uncontrollably away from the main frame into the end setting for hand truck operation that is limited by a stop. For this, a further lowering of the main frame is required, preferably, however, a corresponding pivoting adjustment of the handle section of the subframe that projects upwards over the main frame. To convert the hand truck into a sack truck, the main frame, with its handle end, must be pivoted up around the axles of the running wheels, wherein, owing to the link guide, the handle section of the subframe is pushed into the sliding guide and the subframe is pivoted against the main frame until the end setting for sack truck operation is reached.

In the end setting of the subframe for sack truck operation, the subframe can advantageously be locked with the main frame against pivoting in order to prevent an unintentional pivoting of the subframe.

### BRIEF DESCRIPTION OF DRAWINGS

The features and components of the following figures are illustrated to emphasize the general principles of the present disclosure. Corresponding features and components throughout the figures can be designated by matching reference characters for the sake of consistency and clarity. All characteristics and dimensions displayed in the following figures, such as lengths, thicknesses, and the like, are intended as examples only and do not limit the possible characteristics and dimensions of the present disclosure.

FIG. 1 shows a side view of a sack truck according to the invention,

FIG. 2 shows the said sack truck in a view looking at the subframe,

FIG. 3 shows the sack truck in an intermediate position of the conversion into a hand truck in a side view in a smaller scale and

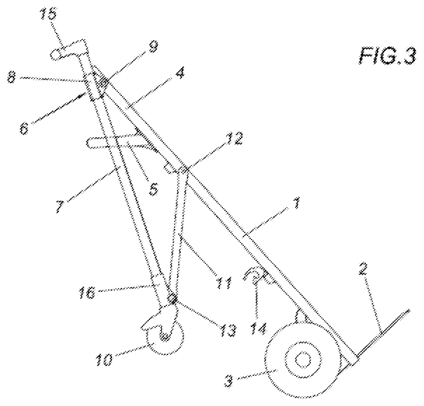

FIG. 4 shows a side view of the sack truck converted into a hand truck, likewise in a smaller scale.

### DETAILED DESCRIPTION OF THE INVENTION

It should be appreciated that this disclosure is not limited to the devices and components described herein. It is also to be understood that the terminology used herein is for the purpose of describing certain embodiments only, and is not intended to be limiting, since the scope of the present disclosure will be limited only by the appended claims.

Unless defined otherwise, all technical and scientific terms used herein have the same meaning as commonly understood by one of ordinary skill in the art to which this disclosure belongs. Any devices and components similar or equivalent to those described herein can be used in the practice or testing of the present invention. All publications mentioned are incorporated herein by reference in their entirety.

The use of the terms “a,” “an,” “the,” and similar referents in the context of describing the presently claimed invention (especially in the context of the claims) are to be construed to cover both the singular and the plural, unless otherwise indicated herein or clearly contradicted by context.

Recitation of ranges of values herein are merely intended to serve as a shorthand method of referring individually to each separate value falling within the range, unless otherwise indicated herein, and each separate value is incorporated into the specification as if it were individually recited herein.

Use of the term “about” is intended to describe values either above or below the stated value in a range of approx. +/−15%; in other embodiments the values may range in value either above or below the stated value in a range of approx. +/−10%; in other embodiments the values may range in value either above or below the stated value in a range of approx. +/−5%; in other embodiments the values may range in value either above or below the stated value in a range of approx. +/−2%; in other embodiments the values may range in value either above or below the stated value in a range of approx. +/−1%. The preceding ranges are intended to be made clear by context, and no further limitation is implied. All methods described herein can be performed in any suitable order unless otherwise indicated herein or otherwise clearly contradicted by context. The term “exemplary” as used herein refers to an aspect, embodiment, feature, or the like that is intended to serve as an example of a particular aspect, embodiment, feature, or the like of the present disclosure. “Exemplary,” as used herein is not intended to limit the disclosure in any way. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

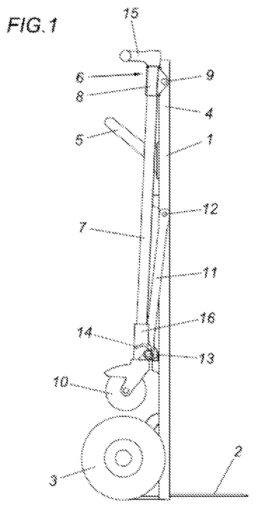

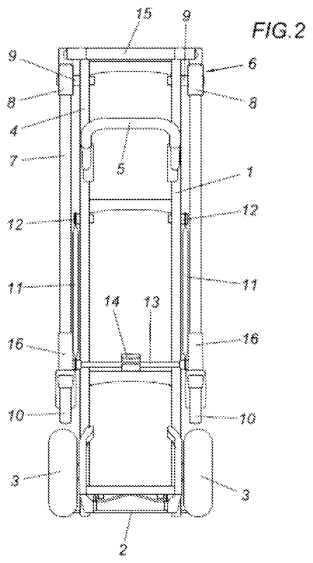

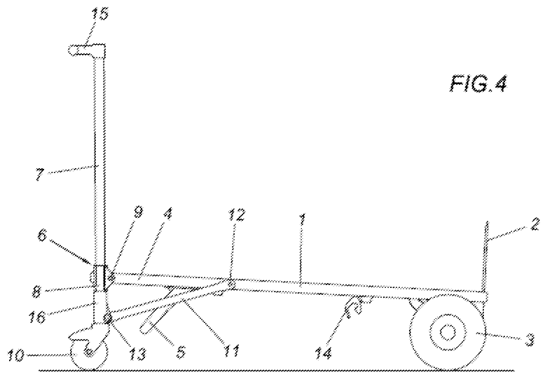

A sack truck according to the invention comprises a main frame 1, which has a receiving nose plate 2 at the foot end and two running wheels 3 on the side opposite the receiving nose plate 2. A sliding guide 6 for a subframe 7 is provided at the opposite handle end 4 of the main frame 1 which is provided with a handle 5 on the running wheel side, which sliding guide is made up of a guide sleeve 8 for each of the two frame legs of the subframe 7. These guide sleeves 8 are rotatably mounted on the handle end 4 of the main frame 1 about a pivot axis 9 parallel to the axes of the running wheels 3. The subframe 7 is therefore mounted in the sliding guide 6 so that it can slide freely between a pushed-in end position corresponding to the sack truck position as shown in FIG. 1 and FIG. 2 and a pull-out position that is limited by a stop corresponding to the hand truck position as shown in FIG. 4, in which the steering wheels 10 arranged at the foot end of the subframe 7 come to rest below the main frame 1. In the sack truck position, the steering wheels of the subframe 7 are located above the running wheels 3 in a rest position.

A link 11 is provided between the main frame 1 and the subframe 7, the articulation axes 12, 13 of which run parallel to the pivot axis 9 of the subframe 7. In the sack truck position, the articulation axis 13, arranged above the steering wheels 10 between the subframe 7 and the link 11, serves to lock the subframe 7 to the main frame 1, which for this purpose forms a catch mechanism 14 for the articulation axis 13. In the sack truck position, the articulation axis 12 between the main frame 1 and the link 11 is approximately centered between the pivot axis 9 and the articulation axis 13, as can be seen in FIG. 1.

To convert the sack truck into a hand truck, the articulation axle 13 must first be released from the mounting latch 14, as shown in FIG. 1, before the subframe 7 can be swung out about the pivot axle 9 from the main frame 1. The link 11 thereby forms a constraining guide for the subframe 7, both with regard to the sliding movement and with regard to the pivot movement dependent on the sliding movement. Since the weight load of the subframe 7, in particular, applies a weight moment to the link 11, which counteracts a swinging out of the subframe 7, the subframe 7 is displaced in a controlled manner around the axis of its running wheels 3 as a function of the tilting movement of the main frame 1, in the sense of a conversion into a hand truck, until the steering wheels 10 of the subframe 7 rest on the ground and thus form a support for the subframe 7. As a result of this ground support for the subframe 7, the end setting for the hand truck as shown in FIG. 4 can be reached by pivoting it about the pivot axis 12. This pivoting adjustment of the subframe 7 is easy to handle because the handle section of the subframe 7, which is provided with a handle 15, protrudes upwards over the main frame 1 via the sliding guide 6 and is freely accessible.

In the end setting, in which the extension path of the subframe 7 is limited by a stop 16 which interacts with the guide sleeves 8, the triangular bracket formed by the articulation axes 12, 13 of the link 11 and the pivot axis 9 provides rigid support for the subframe 7 relative to the main frame 1, which forms a support platform, as a prerequisite for easy handling of the hand truck by the handle section of the subframe 7.

To convert the hand truck into a sack truck, in reverse order, the handle end 4 of the main frame 1 is to be lifted, so that the guide sleeves 8 of the main frame 1 are lifted off the stops 16 of the subframe 7 and the guide sleeves 8 are shifted along the subframe 7 and at the same time the subframe 7 is pivoted against the main frame 1 due to the link guide until finally the end setting corresponding to the sack truck position is reached, in which the subframe 7 is again locked to the main frame 1.

Although several aspects have been disclosed in the foregoing specification, it is understood by those skilled in the art that many modifications and other aspects will come to mind to which this disclosure pertains, having the benefit of the teaching presented in the foregoing description and associated drawings. It is thus understood that the disclosure is not limited to the specific aspects disclosed hereinabove, and that many modifications and other aspects are intended to be included within the scope of any claims that can recite the disclosed subject matter.

It should be emphasized that the above-described aspects are merely possible examples of implementations, merely set forth for a clear understanding of the principles of the present disclosure. Any process descriptions or blocks in flow diagrams should be understood as representing modules, segments, or portions of code which comprise one or more executable instructions for implementing specific logical functions or steps in the process, and alternate implementations are included in which functions may not be included or executed at all, can be executed out of order from that shown or discussed, including substantially concurrently or in reverse order, depending on the functionality involved, as would be understood by those reasonably skilled in the art of the present disclosure. Many variations and modifications can be made to the above-described aspect(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

What is claimed:

1. A sack truck which can be converted into a four-wheeled hand truck, the sack truck comprising:
a. a main frame (1) having:
i. a receiving nose plate (2) at one foot end;
ii. two running wheels (3) on the side opposite the receiving nose plate (2); and
iii. a handle end on the main frame, opposite from the foot end
b. a subframe (7) carrying at least one steering wheel (10) in a foot region;
c. a sliding guide (6) for the subframe (7), the sliding guide pivotable at the handle end (4) of the main frame (1) about a pivot axis (9) parallel to the axes of the running wheels (3); and
d. a link (11) between the main frame (1) and the subframe (7), wherein the link is articulated on the subframe (7) in the foot region thereof about an axis (13) parallel to the pivot axis (9),
wherein the subframe (7) is guided in the sliding guide (6) so that it can slide freely between two end positions that are limited by stops that determine the sack truck position on the one hand and the hand truck position on the other, and in that the link (11) is mounted on the main frame (1) so as to be fixed and pivotable.

2. The sack truck according to claim 1, characterized in that the subframe (7) can be latched to the main frame (1) in the sack truck position to prevent it from pivoting.
